(19) United States
(12) Patent Application Publication
(10) Pub. No.: US 2026/0091685 A1
(43) Pub. Date: Apr. 2, 2026

(54) MULTI-BRAKING SYSTEM BATTERY LIFE MANAGEMENT

(71) Applicant: Caterpillar Inc., Peoria, IL (US)

(72) Inventor: Karl P. Schneider, Decatur, IL (US)

(73) Assignee: Caterpillar Inc., Peoria, IL (US)

(21) Appl. No.: 18/903,614

(22) Filed: Oct. 1, 2024

(51) Int. Cl. B60L 7/18; B60L 1/00; B60L 15/20; B60L 58/12; B60L 58/16; H01M 10/42; H01M 10/44; H01M 10/46; H01M 10/48; H01M 50/249; H02J 7/14

(52) U.S. Cl. CPC B60L 7/18; B60L 1/00; B60L 15/2018; B60L 58/12; B60L 58/16; H01M 10/425; H01M 10/44; H01M 10/46; H01M 10/486; H01M 50/249; H02J 7/1438; B60L 2240/12; B60L 2240/545; B60L 2240/549; H01M 2010/4271; H01M 2220/20

(57) ABSTRACT

Provided herein are systems and methods for managing battery life of a vehicle during a braking condition. For example, the system may include a battery, a traction motor communicably coupled to the battery, a processing circuit including one or more processors and memory, the memory storing instructions that, when executed, cause the processing circuit to detect a braking event for the battery, receive metrics of the battery during the braking condition, and cause the traction motor to supply electrical charge to one or more secondary systems of the vehicle.

### TECHNICAL FIELD

The present implementations relate generally to battery management systems and more particularly to systems and methods of battery management system of a battery for vehicles such as heavy vehicles.

### BACKGROUND

A machine braking condition resulting in battery regeneration may increase the degradation of the machine battery. Such batteries degrade with energy throughput as current is applied with regenerative braking, but the rate of degradation may vary with conditions under the control of a battery life management system, including current, temperature, state of charge, depth of discharge, and state of health.

For example, U.S. patent application Ser. No. 17/543,897 describes a method for braking a hybrid electric vehicle, a hybrid electric vehicle, and a computer program element. The method includes actuating braking with a brake energy, starting to regenerate the brake energy and charging a battery system with the regenerated brake energy, receiving a state of charge of the battery system, redirecting the regenerated brake energy into an integrated starter generator in case of a full or limited charging of the battery system, and activating the integrated starter generator to rotate an internal combustion engine.

### SUMMARY

A first aspect provided herein relates to a system. The system may include a battery, a traction motor communicably coupled to the battery, a processing circuit comprising one or more processors and memory, the memory storing instructions that, when executed, cause the processing circuit to detect a braking condition of the vehicle, receive one or more metrics of the battery during the braking condition, and cause the traction motor to supply electrical charge to at least one of the battery or a secondary system, according to the one or more metrics of the battery during the braking condition.

A second aspect provided herein relates to a vehicle. The vehicle may include a battery, a traction motor communicably coupled to the battery, a processing circuit comprising one or more processors and memory, the memory storing instructions that, when executed, cause the processing circuit to detect a braking condition of the vehicle, receive one or more metrics of the battery during the braking condition, and cause the traction motor to supply electrical charge to at least one of the battery or a secondary system, according to the one or more metrics of the battery during the braking condition.

A third aspect provided herein relates to a method. The method may include detecting, by one or more processors, a braking condition of a vehicle, and, responsive to detecting the braking condition, receive one or more metrics of the battery, compare the one or more metrics of the battery to a threshold, select a secondary system based on metrics exceeding the threshold, and cause a traction motor to supply electrical charge to at least one of the battery or the secondary system, according to the one or more metrics of the battery during the braking condition.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system for battery life management, in accordance with present implementations.

FIG. 2 is a flowchart diagram of a process of battery life management by power reallocation, in accordance with present implementations;

FIG. 3 is a flowchart diagram of a process for battery life management by speed modulation, in accordance with present implementations;

FIG. 4 is a flowchart diagram of a process for battery life management by power reallocation and speed modulation, in accordance with present implementations.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Referring to the FIGURES, systems and methods described herein may be configured, designed, or otherwise arranged to manage battery life of a multi-braking system through a battery life management system. During a braking condition, the battery life management system may reallocate power in a vehicle to limit degradation of the battery. For example, the battery life management system may adjust battery regeneration capacity of the battery based on a predetermined configuration setting. In certain implementations, the battery life management system may reallocate power to a secondary system based on maps of future downhill conditions. The battery life management system may also adjust the vehicle braking speed based on the braking condition. For example, the battery life management system may cause the vehicle to begin reducing speed earlier based on the predetermined configuration setting. In certain implementations, the battery life management system may prevent the vehicle from exceeding a maximum speed based on maps of future downhill conditions. Adjusting the vehicle's power allocation and/or speed based on a braking condition accurately predicted according to current demands from the battery life management system during a braking event may facilitate increasing battery life efficiency as compared to conventional techniques.

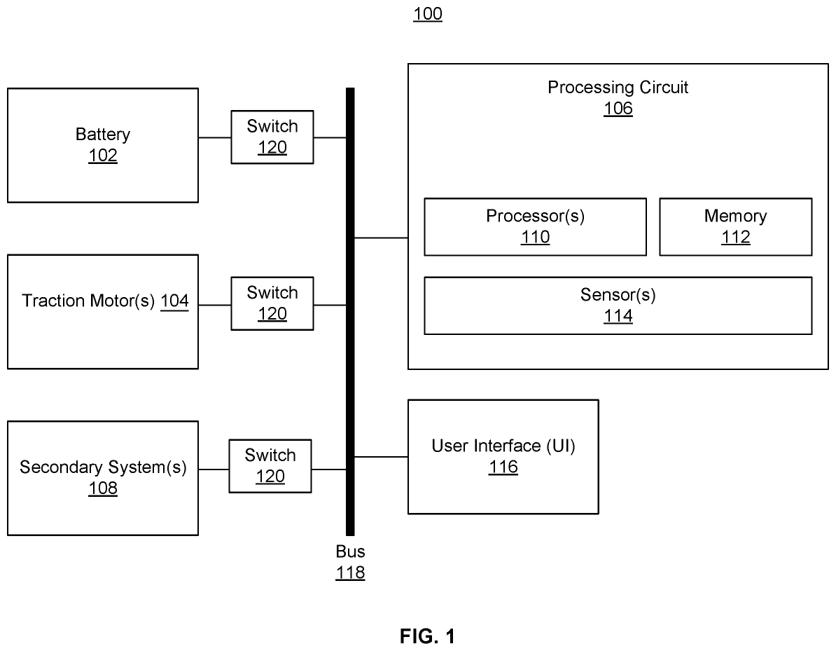

Referring now to FIG. 1, depicted is a block diagram of an energy system 100 for managing battery life within a vehicle. For example, the energy system 100 may be coupled to or incorporated in various types of vehicles including, but not limited to, heavy vehicles (e.g., machinery or construction vehicles including, but not limited to, bulldozers, excavators, loaders, graders, forklifts, mining trucks, semi-trucks, dump trucks, concrete mixers, tanker trucks, flatbed trucks, heavy haulers, etc.), electric vehicles, aviation and/or marine vehicles, locomotives, and/or various other types or forms of vehicles. As described herein, the energy system 100 may include at least one battery 102 to provide and receive electric power to operate the vehicle. The energy system 100 may include various traction motors 104 to recover energy lost during braking (e.g., as electrical charge) and convert the energy back into usable electrical energy to operate the vehicle 100. The energy system 100 may include a processing circuit 106 configured to reallocate power, and/or adjustments of speed of the vehicle, according to various battery metrics, to preserve vehicle and/or battery health. In various embodiments, the processing circuit 106 may be configured to allocate power to various components of the vehicle, such as secondary systems 108.

The energy system 100 may include at least one battery 102 configured to power the vehicle. For example, the energy system 100 may be equipped with lead-acid batteries such as flooded lead-acid, sealed lead-acid (SLA), and valve-regulated lead-acid (VRLA) batteries. In some implementations, the energy system 100 may be equipped with lithium-ion batteries such as lithium-iron-phosphate (LiFePO4), lithium nickel manganese cobalt oxide (NMC), and lithium-ion polymer (Li—Po) batteries. In some implementations, nickel-cadmium (NiCd) batteries may be used to power the vehicle. As described in greater detail below, the energy system includes the processing circuit 106 configured to detect various metrics of the battery 102 for controlling power flow. The metrics may include, but not limited to, effective full cycles (EFC) of the battery 102 (e.g., quantifies the usage and lifespan of rechargeable batteries), state of charge (SOC) of the battery 102 (e.g., a percentage charge, a percentage depletion, a remaining run time, and so forth), state of health (SOH) of the battery 102 (e.g., based on capacity and/or resistance as percentages of an initial capacity and resistance), C-rate (e.g., rate at which a battery 102 is charged or discharged relative to its maximum capacity), temperature, and the depth of discharge of the current cycle.

The energy system 100 may include one or more traction motors 104 communicably coupled to the battery 102. The traction motors 104 may be designed or configured to convert kinetic energy back into electrical energy during braking or deceleration. The traction motors 104 may include one or more regenerative motors. For example, the energy system 100 may include various types of traction motors 104 including, but not limited to, direct current (DC) motors (e.g., series DC motors or shunt DC motors), alternating current (AC) motors (e.g., induction motors or synchronous motors), brushless DC motors (BLDC), permanent magnet motors (e.g., permanent magnet synchronous motors (PMSM) or permanent magnet DC motors (PMDC)), switch reluctance motors (SRM), or various other regenerative motors. In certain implementations, the traction motors 104 are coupled to the processing circuit 106 to manage vehicle operation and to control motor speed, torque, and power output.

The energy system 100 may include the processing circuit 106 configured to control and/or monitor the battery 102 of the system 100. The processing circuit 106 may include at least one processor 110 and memory 112. The processor(s) 110 may be or include any device, component, element, or hardware designed or configured to perform the various steps recited herein. For example, the processor(s) 110 may include any number of general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein.

In some implementations, the energy system 100 may include a single processor 110 designed or configured to perform each of the various steps or acts recited herein. In some implementations, the energy system 100 may include multiple processors 110 which are designed or configured to perform (e.g., either separately or together) each of the various steps or acts recited herein. As one example, the energy system 100 may include a first processor 110 designed or configured to perform a first subset of the various steps or acts, and a second processor 110 designed or configured to perform a second subset of the various steps or acts (with the first subset being different from the second subset). As another example, the energy system 100 may include first and second processors 110 which together perform the various steps in a distributed fashion. As such, unless explicitly indicated otherwise, such as by use of a term such as “a single processor”, the term “one or more processor(s)” as used herein contemplates and encompasses implementations in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all the recites steps or features and two or more processors working individually or in combination, where each step or feature is performed by any one or combination of two or more of the processors. Moreover, the use of the term “one or more processors” may refer to the processor(s) 110 of the energy system 100 and/or the processors of other components of the system 100 described herein.

The processing circuit 106 may include one or more sensors configured or arranged to sense various conditions of the energy system 100. For example, the sensor(s) 110 may include any number of voltage sensors, current sensors, temperature sensors, state of charge (SOC), state of health (SOH) sensors, balancing sensors, pressure sensors, accelerometers, location/GPS sensors, speed sensors, operator input sensors (e.g., pedal, lever, speed control), or any combination thereof configured or arranged to sense various conditions recited herein. As another example, the processing circuit 106 may include via one or more sensors 114 configured to sense a braking condition of the vehicle, a change in speed of the vehicle (e.g., increase/decrease in speed), or an idle condition of the vehicle. As another example, the processing circuit 106 may include via one or more sensors 114 configured to sense metrics of the battery such as voltage, EFC, SOC, SOH, C-rate, and temperature.

In some implementations, the energy system 100 may include a sensor 114 configured or arranged to sense various conditions of the energy system 100. The sensor may be configured or arranged to sense various conditions of the battery 102. The sensor may be configured or arranged to sense various conditions of the vehicle equipped with the energy system 100. In some implementations, the energy system 100 may include multiple sensors 114 which are designed or configured to sense (e.g., either separately or together) various conditions recited herein. As one example, the energy system 100 may include a first sensor 114 designed or configured to sense a first subset of metrics of the battery, and a second sensor 110 designed or configured to sense a second subset of metrics of the battery 102 (with the first subset being different from the second subset). As another example, the energy system 100 may include first and second sensors 114 which together sense the various metrics of the battery 102 in a distributed fashion. As such, unless explicitly indicated otherwise, such as by use of a term such as “a single sensor”, the term “one or more sensor(s)” as used herein contemplates and encompasses implementations in which all of the one or more sensors perform all of the recited steps or features, different sensors separately perform different ones of the steps or features, the same or different sets of two or more sensors work in combination to perform individual steps or features, or any variation thereof. In other words, the use of the term “one or more sensors” may refer to the sensors(s) 114 of the energy system 100 and/or the sensors of other components of the system 100 described herein.

The processing circuit 106 may be communicably coupled to a battery 102 of the energy system 100. The processing circuit 106 may be structured or configured to monitor and/or manage various metrics of the battery 102 including, but not limited to, EFC, C-rate, a temperature, SOC, and/or SOH. The processing circuit 106 may be configured to additionally or alternatively monitor and/or manage a runtime, number of charge cycles, an internal resistance, a self-discharge rate, a cell temperature, a time history of various conditions, an impedance, and/or various other conditions of the battery 102. For example, the processing circuit 106, via the one or more processors 110, may be configured to receive metrics of the battery 102 from one or more sensors 114 (e.g., voltage sensors, current sensors, temperature sensors, etc.) and/or from one or more monitoring circuits communicably coupled to the battery 102. The processing circuit 106 may additionally be communicably coupled to one or more processors 110 within or external to the system 100 including, for example, a vehicle control unit (VCU), or another control unit (e.g., an external off-machine communication from a dispatch system), to receive and/or provide information about the battery 102 to another portion of the system 100 or vehicle.

The processing circuit 106 may be configured to detect a condition of the vehicle. The condition may refer to a state in which the vehicle is decelerating or coming to a stop. In some implementations, the processing circuit 106 may be configured to detect a condition relating to a grade of the vehicle (e.g., the vehicle driving at a constant/steady-state speed but up/down a grade). In other words, the condition may be influenced by/correspond to the type of braking system, driving conditions, and/or state of the vehicle. In certain implementations, the condition may be based on actuation of a vehicle brake. For example, actuation of the vehicle brake may be detected through one or more sensors 114 (e.g., brake pedal position sensors, pressure sensors, motor position sensors, energy flow sensors, etc.) communicably coupled to the processing circuit 106. During actuation of the vehicle brake, the processing circuit 106 may confirm the braking system has been engaged via the one or more sensors 114. As another example, the braking condition may be based on a change in a value from a speedometer in the vehicle (e.g., reduction of speed). During vehicle operation, a speedometer sensor continuously measures the vehicle's speed and directs measurements to the processing circuit 106. The processing circuit 106 may detect reductions in speed based on the measurements detected from the speedometer. As another example, the braking condition may be based on data collected from an accelerometer of the vehicle (e.g., negative acceleration). During negative acceleration, the rate at which the vehicle is traveling decreases over time due to opposing forces on the vehicle such as braking and friction. As a result, an accelerometer sensor coupled to the accelerometer and the processing circuit 106 may detect a change in velocity when the brake system is engaged. The data collected from the accelerometer sensor may be analyzed by the processing circuit 106 to confirm if the braking condition had occurred.

In some implementations, the processing circuit 106 is configured with a battery life degradation limit, otherwise stated as a “threshold” herein, to control battery lifespan within the vehicle. The threshold may be a predetermined configuration setting established by an operator or a manufacturer prior to operation of the vehicle. The threshold may be a combination of metrics including, but not limited to, current, temperature, and SOC as defined by an onboard degradation model. The onboard degradation model may be a function of a degradation coefficient (e.g., a parameter that quantifies the rate at which the battery's capacity and performance decline over time due to usage, environmental conditions, aging, etc.) of the battery 102 and current flow into/out of the battery 102. The current flow may depend on the C-rate metric outputted by one or more sensors 114 in the processing circuit 106 of the energy system 100. In some implementations, the threshold may be computed/derived as a function of SOH, rather than an instantaneous value. In some implementations, the energy system 100 may set the threshold to the degradation coefficient of the battery. In some implementations, the threshold may be manually adjusted by an operator as the degradation coefficient of the battery 102 may change due to aging.

In some implementations, the processing circuit may include, set, determine, or otherwise configure a threshold based on site maps of future downhill conditions. Using the site map to establish a threshold may allow the operator to customize the vehicle to operate at improved efficiency and performance at a predetermined location. For example, one or more processors 110 of the processing circuit 106 may be programmed with locations of hills, slopes, or steep drop-offs on a construction site, haul roads, pit and dump ramps, in a mine site, and so forth. As another example, the processor(s) 110 may be configured to access location of such information (e.g., hills, slopes, drop-offs, haul road, pit and dump ramps, and so forth) from a third-party server or service (e.g., a cloud service, an elevation map hosted or provided by a third-party resource, and so forth). The site features may be stored in the memory 112 of the processing circuit 106, or otherwise accessed and used by the processing circuit 106, as indicators to manage the battery 102 when reached. When the vehicle may be operated, one or more sensors 114 (e.g. a location/GPS sensor) may communicate the location of the vehicle in relation to the site features. As the vehicle approaches the site feature, the vehicle location may satisfy the threshold.

In some implementations, the processing circuit 106 may be configured to monitor the health of the battery 102 during vehicle operation. The processing circuit 106 may detect and evaluate metrics of the battery during vehicle operation using one or more processors 110 (e.g., single- or multi-chip processors, DSPs, ASICs, FPGAs, or other programmable logic device(s)) 110 and one or more sensors (e.g., voltage sensors, current sensors, temperature sensors, etc.) 114. In some implementations, the processing circuit 106 may be configured to receive information of the battery 102 in real-time or near real-time. In some implementations, the processing circuit 106 may calculate a degradation rate (e.g., the instantaneous degradation rate, the time average degradation rate, a rate of change of the degradation rate) using metrics of the battery 102 during vehicle operation. For example, the processing circuit 106, via the one or more processors 110, may be configured to receive and calculate the degradation rate using metrics of the battery 102 including EFC, SOC, SOH, C-rate, and temperature of the battery 102 from one or more sensors 114 and/or from one or more monitoring circuits communicably coupled to the battery 102. The degradation rate may be instantaneous or time averaged.

In some implementations, the processing circuit 106 is configured to calculate the degradation rate using one or more battery derate tables. The battery derate tables may contain values that correspond to metrics transmitted from one or more sensors 114 of the battery 102 to the processing circuit 106 responsive to receiving the information. The battery derate tables may include temperature derating (e.g., information on how the battery capacity decreases at different temperatures), loading derating (e.g., data on how different discharge rates affect battery capacity), and cycle life derating (e.g., data on how the number of charge-discharge cycles impact battery capacity). In some implementations, the processing circuit 106 may calculate a degradation rate coefficient (e.g., parameter that quantifies the rate at which a battery's performance degrades over time due to various factors such as cycling, temperature, and aging) based on data from the battery derate tables. The processing circuit 106 may then calculate degradation rate by multiplying the degradation rate coefficient by the C-rate to derive the degradation rate of the vehicle.

In some implementations, the processing circuit 106 may compare the degradation rate to the established threshold to determine if the threshold has been satisfied (e.g., met or exceeded). The processing circuit 106 may retrieve the degradation rate (e.g., instantaneous and/or time average degradation rate) from the system memory or otherwise determined by the processing circuit 106. The processing circuit 106 may retrieve the threshold from the system memory. The processing circuit may execute a comparison instruction to evaluate the relationship between the two values. For example, comparison operations may be performed by an arithmetic logic unit (ALU) within the processing circuit 106. Based on the result of the comparison, the processing circuit 106 may set condition flags in the memory of the processing circuit 106 to alert the processing circuit 106 if the degradation rate is greater than/less than the threshold. In some implementations, the processing circuit 106 may decrease the battery regeneration capacity or decrease the battery regeneration speed limit if the degradation rate exceeds the threshold. In some implementations, the processing circuit 106 may increase the battery regeneration capacity or increase the battery regeneration speed limit if the degradation rate is below the threshold. The processing circuit 106 may divert power to one or more secondary systems to prevent excess power from degrading the battery 102.

The energy system 100 may include one or more secondary systems 108. The secondary systems 108 may be designed or configured to dissipate power from the machine 102 and/or manage the lifespan of the battery 102. For example, the energy system 100 may include various types of secondary systems 108 including, but not limited to, a resistive grid, a hydraulic pump, an engine brake, or an accessory within the vehicle. In an exemplary implementation, the resistive grid is coupled to the battery 102 and traction motors 104 as the secondary system 108. When the processing circuit 106 diverts power to the secondary system, the resistive grid may dissipate heat through a process of converting electrical energy into thermal energy. The resistive grid may be configured to dissipate heat from the battery 102 using conduction (e.g., heat is transferred from the resistive elements to adjacent cooler materials) or convection (e.g., heat is dissipated by movement of air by a fan or blower).

In some implementations, a hydraulic pump may be coupled to the battery 102 and traction motors 104 as the secondary system 108. The hydraulic pump may convert mechanical energy generated from mechanical losses (e.g., friction or slippage) and/or hydraulic losses (e.g., pressure drop or viscous drag) into thermal energy. The hydraulic pump may then use conduction through a pump housing or convection through cooling systems (e.g., heat exchangers or oil coolers) to dissipate the thermal energy.

In some implementations, an engine brake may be coupled to the battery 102 and traction motors as the secondary system 104. The engine brake may use the vehicle's engine as a pump to dissipate power otherwise directed to the battery 102 for regeneration. In some implementations, vehicle accessories (e.g. pumps or fans) may be coupled to the battery 102 and traction motors 104 as the secondary system 108. For example, the vehicle engine may be operated in reverse via a backdrive to intentionally consume power otherwise directed towards recharging the battery 102. As another example, fans or pumps present within the vehicle may directly or indirectly consume power as the secondary system 108.

In some implementations, the operator may choose whether to adjust machine speed or direct power to one or more secondary systems 108 based on a user interface input. The user interface may include, but limited to, a digital instrument cluster or an infotainment display equipped with tactile buttons or touchscreen capabilities within the vehicle. For example, the vehicle may include an LCD or LED screen that displays information including SOC, SOH, and degradation rate based on the threshold (e.g., if the threshold has been satisfied, prompting an action to be selected) of the battery 102. The operator may then be able to select an action to resolve any battery alerts displayed on the user interface. The actions may include adjusting machine speed or allocating power to one or more secondary systems 108. The operator may be able to choose between a plurality of secondary systems 108 to allocate excess power to. As another example, the vehicle may be configured to communicate vehicle information via a smartphone, tablet, or similar external device to the vehicle. The operator may then resolve battery alerts through inputs on the external device as an alert or notification is communicated and displayed on the external device. Similarly, the operator may be able to choose to adjust machine speed or divert power to choose the plurality of secondary systems 108 present in the vehicle through a user interface input on the external device.

In some implementations, components of the energy system 100 are connected via a bus 118. The bus may serve as a common electrical junction that connects the battery 102, the one or more traction motors 104, the processing circuit 106, the one or more secondary systems 108, and the user interface 116. Switches 120 may be present, positioned, or otherwise located between the battery 102 and the bus 118, the traction motor(s) 104 and the bus 118, and the secondary system(s) 108 and the bus 118. The switches 120 may control the flow of energy from the traction motor(s) 104 and the battery 102. The switches 120 may control the flow of energy from the traction motor(s) 104 and the secondary system(s) 108. For example, the processing circuit 106 may transmit signals to the switches 120 to open or close, to control the flow of energy from the traction motor(s) 104.

### INDUSTRIAL APPLICABILITY

The disclosed implementations may be applicable to any battery-based system or solution. For example, the disclosed implementations may be applicable to or applied to a vehicle as described herein, such as an automobile, heavy machinery, or any other type of vehicle, a power source for a home, office, or any other residential/industrial setting, or any other power delivery system which may be powered by a battery pack. The disclosed implementations may be applicable to battery-based systems which use or include one or more battery life management systems configured to regulate the battery life and performance of the battery or other components during operation of the system.

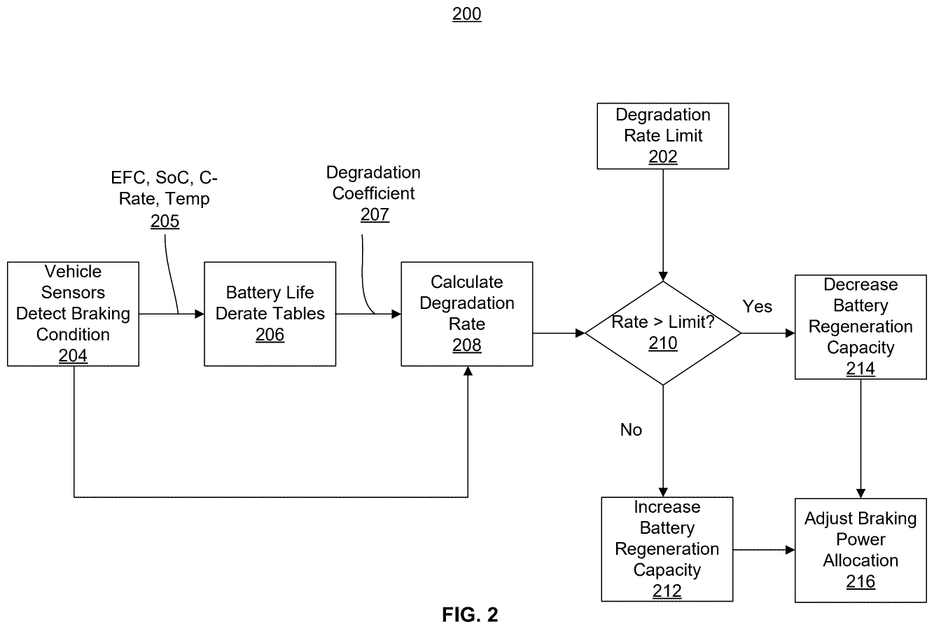

Referring now to FIG. 2, depicted is a flowchart showing an example process 200 of battery life management of a battery using a threshold. The process 200 may be executed to control battery power allocation within the vehicle. The process 200 may be performed by, implemented on, or otherwise executed by the components, elements, or hardware described above with reference to FIG. 1. For example, the process 200 may be executed by the system 100 of FIG. 1.

At act 202, the process 200 may begin. The processing circuit may be configured with a battery life degradation rate limit (e.g., threshold). The threshold may be a predetermined configuration setting established by a manufacturer prior to operation of the vehicle. In some implementations, the threshold may be manually adjusted by an operator following a period of usage. The threshold may be adjusted as the degradation coefficient of the battery changes, due to wear on the vehicle. In some implementations, the threshold may be qualitatively provided to the operator (e.g. low, medium, high) and may be adjusted as desired. The threshold for a given setting may adapt with time to reflect the battery physics (e.g., degradation coefficient decreases with SoH and time) during operation.

In act 204, the system 100 may be configured to receive or determine information of the battery through the one or more sensors or monitoring circuits of the battery following a braking condition. For example, the processing circuit (e.g., via the one or more processors) may receive and/or determine metrics of the battery 203 including, but not limited to, effective full cycles (EFC) of the battery (e.g., quantifies the usage and lifespan of rechargeable batteries), state of charge (SOC) of the battery (e.g., a percentage charge, a percentage depletion, a remaining run time, and so forth), state of health (SOH) of the battery (e.g., based on capacity and/or resistance as percentages of an initial capacity and resistance), C-rate (e.g., rate at which a battery is charged or discharged relative to its maximum capacity), and temperature. In some implementations, the processing circuit may receive information of the battery in real-time or near real-time. In some implementations, the processing circuit may receive information of the battery over a time window (e.g., over a previous, present, or future operating time window of the battery). For example, the processing circuit may receive operational information of the battery from the past (e.g., from the previous 15 seconds—10 minutes), for the present or near-present (e.g., from the previous 15 seconds—the future 15 seconds), or for the future (e.g., the future 15 seconds—10 minutes). For example, the processing circuit may receive one or more of the SOC, change in SOC, or estimated future SOC, the voltage, change in voltage, or future voltage, the current demand, the change in current demand, or the future current demand, and/or the SOH, the change in SOH, or an estimated future SOH of the battery. In some implementations, the processing circuit may determine the metrics of the battery 205 responsive to receiving the information.

In act 206, the processing circuit may store detected metrics of the battery into battery derate tables. For example, the battery derate tables may include temperature derating (e.g., information on how the battery capacity decreases at different temperatures), loading derating (e.g., data on how different discharge rates affect battery capacity), cycle life derating (e.g., data derived from a battery capacity curve with each charge-discharge cycle, which is then multiplied by other factors such as C-rate, temperature, SoC, and depth of discharge), and SOC derating (e.g., data on how the system adjusts operational limits based on the current charge level). In some implementations, the processing circuit may receive and store information of the battery into the battery derate tables in real-time or near real-time. The processing circuit may calculate the degradation rate coefficient 207 (e.g., parameter that quantifies the rate at which a battery's performance degrades over time due to various factors such as cycling, temperature, and aging) based on the battery derate tables. The degradation rate coefficient 207 may be dynamic and update instantaneously depending on conditions of the vehicle including increasing/decreasing speed and remaining idle. The degradation rate coefficient 207 may adjust based on a time average depending on a period between vehicle activation and deactivation. In act 206, the processing circuit may calculate degradation rate by multiplying the degradation rate coefficient 207 by the C-rate the battery. The C-rate of the battery may be detected by a sensor in the battery and transmitted to the processing circuit. In some implementations, the C-rate may be stored in the battery derate tables and then extracted from the battery derate tables to derive the degradation rate of the battery.

In act 210, the processing circuit may compare the degradation rate to the established threshold to determine if the threshold has been satisfied during the braking condition. The processing circuit may elect to respond to the condition by increasing or decreasing the battery regeneration capacity. In act 212, the processing circuit may respond to the degradation rate exceeding the established threshold by increasing the battery regeneration capacity. In doing so, the processing circuit may direct a large portion of power generated to the battery for recharge purposes. In act 214, the processing circuit may respond to the degradation rate exceeding the established threshold by decreasing the battery regeneration capacity. In doing so, the processing circuit may automatically elect one secondary system from the plurality of secondary systems to divert power to. In some implementations, an operator may choose which secondary system to divert power to from the plurality of secondary systems using an input on the user interface. In act 216, the braking power allocation may adjust based on the degradation rate calculated by the processing circuit and compared to the threshold. The braking power allocation may improve battery efficiency and battery life by diverting power away from the battery during vehicle actions that generate significant degradation due to unfavorable conditions.

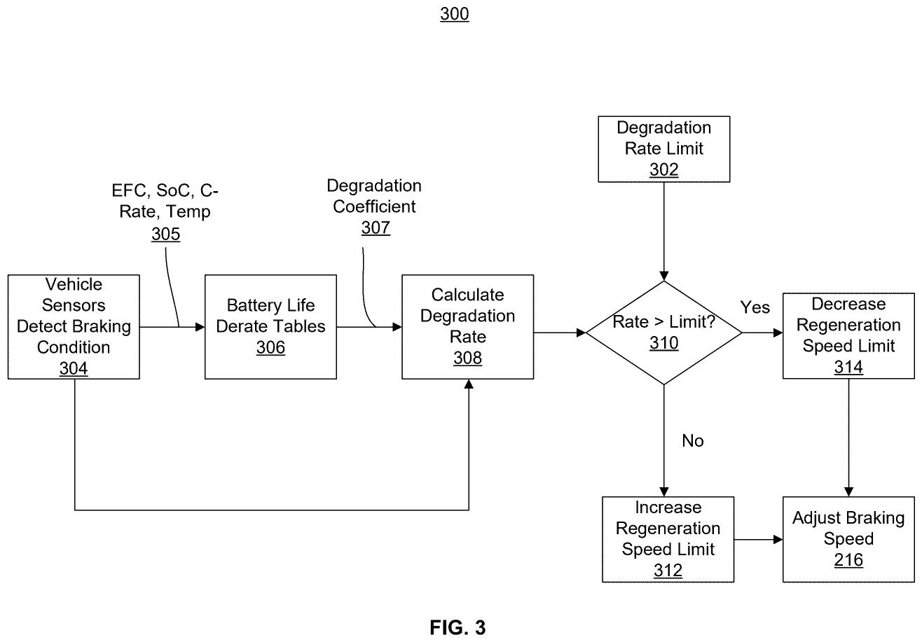

Referring now to FIG. 3, depicted is a flowchart showing an example process 300 of battery life management of the battery using a threshold for controlling vehicle speed within the vehicle. The process 300 may be performed by, implemented on, or otherwise executed by the components, elements, or hardware described above with reference to FIG. 1. For example, the process 300 may be executed by the system 100 of FIG. 1.

At act 302, the process 300 may begin. The processing circuit may be configured with a battery life degradation rate limit (e.g., threshold). The threshold may be a predetermined configuration setting established by a manufacturer prior to operation of the vehicle. In some implementations, the threshold may be manually adjusted by an operator following a period of usage. The threshold may be adjusted as the degradation coefficient of the battery changes due to wear on the vehicle. In some implementations, the threshold may be qualitatively provided to the operator (e.g. low, medium, high) and may be adjusted as desired. The threshold for a given setting may adapt with time to reflect the battery physics (e.g., degradation coefficient decreases with SoH and time) during operation.

In act 304, the system 100 may receive or determine information of the battery through the one or more sensors or monitoring circuits of the battery during a braking condition. For example, the processing circuit (e.g., via the one or more processors) may receive and/or determine metrics of the battery 303 including, but not limited to, effective full cycles (EFC) of the battery (e.g., quantifies the usage and lifespan of rechargeable batteries), state of charge (SOC) of the battery (e.g., a percentage charge, a percentage depletion, a remaining run time, and so forth), state of health (SOH) of the battery (e.g., based on capacity and/or resistance as percentages of an initial capacity and resistance), C-rate (e.g., rate at which a battery is charged or discharged relative to its maximum capacity), and temperature. In some implementations, the processing circuit may receive information of the battery in real-time or near real-time. In some implementations, the processing circuit may receive information of the battery over a time window (e.g., over a previous, present, or future operating time window of the battery). For example, the processing circuit may receive operational information of the battery from the past (e.g., from the previous 15 seconds—10 minutes), for the present or near-present (e.g., from the previous 15 seconds—the future 15 seconds), or for the future (e.g., the future 15 seconds—10 minutes). For example, the processing circuit may receive one or more of the SOC, change in SOC, or estimated future SOC, the voltage, change in voltage, or future voltage, the current demand, the change in current demand, or the future current demand, and/or the SOH, the change in SOH, or an estimated future SOH of the battery. In some implementations, the processing circuit may determine the metrics of the battery 205 responsive to receiving the information.

In act 306, the processing circuit may store detected metrics of the battery into battery derate tables. For example, the battery derate tables may include temperature derating (e.g., information on how the battery capacity decreases at different temperatures), loading derating (e.g., data on how different discharge rates affect battery capacity), cycle life derating (e.g., data derived from a battery capacity curve with each charge-discharge cycle, which is then multiplied by other factors such as C-rate, temperature, SoC, and depth of discharge), and SOC derating (e.g., data on how the system adjusts operational limits based on the current charge level). In some implementations, the processing circuit may receive and store information of the battery into the battery derate tables in real-time or near real-time. The processing circuit may calculate the degradation rate coefficient 307 (e.g., parameter that quantifies the rate at which a battery's performance degrades over time due to various factors such as cycling, temperature, and aging) based on the battery derate tables. The degradation rate coefficient 307 may be dynamic and update instantaneously depending on conditions of the vehicle including increasing/decreasing speed and remaining idle. In act 307, the processing circuit may calculate degradation rate by multiplying the degradation rate coefficient 307 by the C-rate the battery. The C-rate of the battery may be detected by a sensor in the battery and transmitted to the processing circuit. In some implementations, the C-rate may be stored in the battery derate tables and then extracted from the battery derate tables to derive the degradation rate of the battery.

In act 310, the processing circuit may compare the degradation rate to the established threshold to determine if the threshold has been satisfied during the braking condition. The processing circuit may elect to respond to the condition by increasing or decreasing the battery regeneration speed limit. In act 312, the processing circuit may respond to the degradation rate exceeding the established threshold by increasing the battery regeneration speed limit. In doing so, the processing circuit may allow the vehicle to regenerate the battery at a greater speed. In act 314, the processing circuit may respond to the degradation rate exceeding the established threshold by decreasing the battery regeneration capacity. In doing so, the processing circuit may prevent the battery from regenerating at its previous operating rate. The processing circuit may direct the vehicle to perform slower battery regeneration speed to prevent the battery from degrading due to large sums of power. In act 316, the vehicle braking speed may be adjusted based on the degradation rate calculated by the energy system and compared to the threshold. The adjusted braking speed may improve battery efficiency and battery life by diverting power away from the battery during vehicle actions that generate large sums of power. The adjusted braking speed may increase energy recovery as compared to running the machine at a higher speed where energy may be diverted to secondary systems for waste.

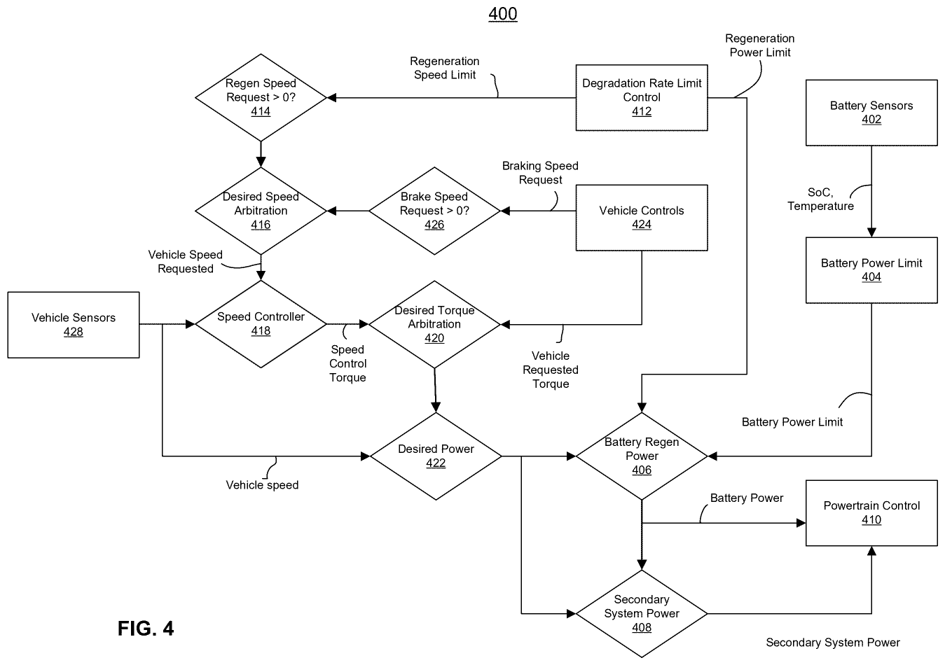

Referring now to FIG. 4, depicted is a flowchart showing an example process 400 of battery life management of the battery using a threshold configured to control battery power allocation and vehicle speed within the vehicle. The process 400 may be performed by, implemented on, or otherwise executed by the components, elements, or hardware described above with reference to FIG. 1. For example, the process 400 may be executed by the system 100 of FIG. 1.

Process 400 includes aspects of process 200 and process 300 to describe how the processing circuit may dictate which approach to use when preventing excessive power from regenerating the battery. The acts described herein may occur simultaneously or sequentially of one another. In act 402, the processing circuit may detect metrics of the battery based on information from one or more sensors. The metrics of the battery may include EFC, SOC, SOH, temperature, and C-rate of the battery. In act 404, the sensor(s) may transmit the metrics of the battery to processors. The processors may determine a battery power limit. In act 406, the processors may use the battery power limit to determine the available battery regeneration power in the energy system. The processors may utilize the battery regeneration power to regenerate the battery or divert power to a secondary system, as shown in act 408. In act 410, the processing circuit may then control the powertrain 410 of the vehicle when the battery generation power 406 and the secondary system power 408 do not satisfy the threshold.

In act 412, a degradation rate limit controller may establish a regeneration power limit using one or more processors of the processing circuit. The regeneration power limit may set a threshold that limits the available battery regeneration power of the energy system from reaching the battery. The degradation rate limit controller may transmit a regeneration speed limit to one or more processors in the processing circuit to determine the correct vehicle speed needed to improve battery performance. In act 414, one or more processors may determine if the regeneration speed request is greater than zero. In act 416, the one or more processors may determine a value for desired vehicle speed for battery performance. In act 418, the processing circuit may transmit the desired vehicle speed to a speed controller. The speed controller may manage the torque output of the wheel motor. In act 420, the processing circuit may calculate a torque for the energy system to produce the desired amount of power based on the desired speed. In act 422, the energy system may calculate the desired amount of power based on the vehicle speed information or torque information that the system generates. The system then may use the desired power to regenerate the battery, or diverts it to a secondary system to maintain powertrain control, as shown in acts 406-410.

In act 424, one or more processors in the processing circuit (e.g., vehicle controller) may determine if adjusting the vehicle speed or torque is predicted to increase/improve the battery performance. The determination may be based on system information such as, but limited to, battery power limit, braking speed request, braking torque request, and/or actual braking torque. In some embodiments, the processing circuit may translate vehicle requests to the powertrain control, irrespective of how they are met (e.g., via regeneration or via a secondary system). For example, the processing circuit may receive a vehicle request from an operating brake input (e.g., a pedal or lever), operator speed control (e.g., cruise control), or system desired speed (e.g., autonomous/external input). In act 426, the vehicle controller may request a brake speed. If the brake speed request is greater than zero, the system may determine the desired speed, at act 416. As a result, the energy system may follow acts 418-422 to manage the vehicle powertrain. The system then may use the desired power to regenerate the battery or diverts it to a secondary system to maintain powertrain control, as shown in acts 406-410. If the processing circuit may signal an adjustment for vehicle torque, acts 420-422 may be followed.

In act 428, one or more sensors of the processing circuit may detect the vehicle speed. The energy system may use the vehicle speed to communicate with the speed controller for cruise control. The energy system may use the vehicle speed to calculate desired power (e.g., torque multiplied by speed) as an operator controls the vehicle. The one or more processors of the processing circuit may adjust the power allocation to either solely recharge the battery or divert a portion of the power to a secondary system to maintain powertrain control, as shown in acts 406-410, according to the determined/calculated desired power. The system then may use the desired power to regenerate the battery or diverts power to a secondary system to maintain powertrain control, as shown in acts 406-410.

As a result of the systems and methods described herein, the energy system may provide longer battery life and high battery performance through prevention of high cyclic degradation during braking events. Extended lifetime of the battery may reduce the operating cost of the battery on a time and throughput basis. Extended lifetime of the battery may increase the number of years the vehicle can be operated at peak efficiency. As a result, adjusting the vehicle's power allocation and/or speed based on a braking condition accurately predicted according to current demands from the battery life management system during a braking event may facilitate increasing battery life efficiency as compared to conventional techniques, where the battery is used up to thermal, electrical, or safety limits without regard for life performance.

What is claimed is:

1. An energy system for a vehicle, the energy system comprising:
a battery;
a traction motor communicably coupled to the battery;
a processing circuit comprising one or more processors and memory, the memory storing instructions that, when executed, cause the processing circuit to:
detect a braking condition of the vehicle;
receive one or more metrics of the battery during the braking condition; and
cause the traction motor to supply electrical charge to at least one of the battery or a secondary system, according to the one or more metrics of the battery during the braking condition.

2. The energy system of claim 1, wherein the instructions further cause the one or more processors to:
compare the one or more metrics of the battery to a threshold; and
allocate power to the secondary system based on the one or more metrics exceeding the threshold.

3. The energy system of claim 2, wherein the threshold is a predetermined configuration setting.

4. The energy system of claim 2, wherein the threshold comprises a battery life degradation rate limit.

5. The energy system of claim 4, wherein a battery degradation rate is calculated from the one or more metrics of the battery to be compared to the threshold.

6. The energy system of claim 2, wherein the threshold comprises a degradation coefficient.

7. The energy system of claim 2 wherein the threshold is a determined based on time variable curve, according to the one or more metrics of the battery.

8. The energy system of claim 1, wherein the one or more metrics of the battery are State of Health (SOH), State of Charge (SOC), current, temperature, and depth of discharge of a current cycle of the battery.

9. The energy system of claim 1, wherein the secondary system comprises at least one of a hydraulic pump, engine brake, resistive grid, fan, or pump within the vehicle.

10. The energy system of claim 1, wherein the system diverts power to the secondary system when a battery life degradation rate limit is exceeded.

11. The energy system of claim 1, wherein the energy system adjusts braking speed when a battery life degradation rate limit is exceeded.

12. The energy system of claim 1, wherein the one or more metrics include SOC, current, and temperature, wherein the secondary system is a resistive grid, and wherein the traction motor supplies the electrical charge to the resistive grid when a battery life degradation rate limit is exceeded.

13. The energy system of claim 1, wherein the secondary system is one of a plurality of secondary systems, wherein the instructions further cause the one or more processors to;
select the secondary system from the plurality of secondary systems by:
receiving an input from a user interface; and
selecting a mode of operation according to the input.

14. The energy system of claim 1, wherein causing the traction motor to supply the electrical charge comprises supplying a first portion of electrical energy generated by the traction motor to the battery and supplying a second portion of the electrical energy generated by the traction motor to the secondary system.

15. The energy system of claim 1, wherein a vehicle speed is controlled based on site maps of future downhill conditions.

16. A vehicle, comprising:
a battery;
a traction motor communicably coupled to the battery;
a processing circuit comprising one or more processors and memory, the memory storing instructions that, when executed, cause the processing circuit to:
detect a braking condition of the vehicle;
receive one or more metrics of the battery during the braking condition; and
cause the traction motor to supply electrical charge to at least one of the battery or a secondary system, according to the one or more metrics of the battery during the braking condition.

17. The vehicle of claim 16, wherein the instructions further cause the one or more processors to:
compare the one or more metrics of the battery to a threshold; and
select the secondary system based on the one or more metrics satisfying the threshold.

18. The vehicle of claim 16, wherein the vehicle diverts power to the secondary system when a battery life degradation rate limit is exceeded.

19. The vehicle of claim 16, wherein the vehicle adjusts braking speed when a battery life degradation rate limit is exceeded.

20. A method of managing a battery, the method comprising:
detecting, by one or more processors, a braking condition of a vehicle; and
responsive to detecting the braking condition,
receive one or more metrics of the battery;
compare the one or more metrics of the battery to a threshold;
select a secondary system based on metrics exceeding the threshold; and
cause a traction motor to supply electrical charge to at least one of the battery or the secondary system, according to the one or more metrics of the battery during the braking condition.
